(19) United States
(12) Patent Application Publication
(10) Pub. No.: US 2012/0312470 A1
(43) Pub. Date: Dec. 13, 2012

(54) Rigid Panel Adhesion Method and a Smearing Module Utilized Thereby

(76) Inventor: Chin-Ho Chen, Kaohsiung City (TW)

(21) Appl. No.: 13/465,067

(22) Filed: May 7, 2012

(30) Foreign Application Priority Data
Jun. 8, 2011 (TW) 100120038

(51) Int. Cl. B32B 37/12; B05C 11/02; B32B 38/00

(52) U.S. Cl. 156/295; 156/60; 118/100

(57) ABSTRACT

The invention discloses a rigid panel adhesion method including a smearing step and a pressing step. The smearing step smears glue on a surface of a first rigid panel to form a glue layer. The glue layer has a single contact portion being in one-dimensional form of a dot or line. The glue layer has a coverage ratio of no less than 50% over the surface of the first rigid panel. The pressing step touches the contact portion of the glue layer with a second rigid panel, and slowly presses the first and second rigid panels together to discharge gases between the first and second rigid panels, thereby adhering the first and second rigid panels to each other.

### BACKGROUND OF THE INVENTION

1. Field of the Invention

The present invention generally relates to a rigid panel adhesion method and, more particularly, to a rigid panel adhesion method for two rigid panels.

2. Description of the Related Art

As continuous development of technology, modern 3C (Computer, Communication, Consumer) products are equipped with a touch panel instead of a keyboard and a mouse for convenience, handiness and customization.

As an example, a touch liquid crystal display device is formed by stacking a liquid crystal displayer, an optical film and a touch panel. The soft optical film is stuck on a surface of the liquid crystal displayer as has been widely adopted by manufacturers. Because both the liquid crystal displayer and the touch panel are rigid, when they are adhered to each other by trundling technology that is supposedly used for adhesion between a soft panel and a rigid panel, a large pressure may be resulted between the liquid crystal displayer and the touch panel. As a result, since the liquid crystal displayer consists of multiple layers and circuits, the pressure may cause damages to the circuits under the surface of the liquid crystal displayer or even break the touch panel. Although a wide range of breakage does not occur between the rigid panels, a significant amount of bubbles may be formed between the rigid panels due to uneven adhesion and face contact of glue therebetween. Thus, the adhesion between the rigid panels is greatly affected, resulting in a difficulty in improving the product yield rate.

Conventionally, the rigid panels are adhered to each other by glue dispensing. In such a manner, glue is dispensed on a surface of one rigid panel along a predetermined path. Then, the other rigid panel can touch the areas where the glue is dispensed, and the rigid panels can be pressed together to complete the adhesion procedure. However, the amount of the glue applied to the surface of the rigid panel cannot be precisely controlled, causing the glue to come out between the rigid panels after the rigid panels are pressed together due to too much glue used or leading to an insufficient use of the glue. As a result, desired adhesion effect is not attained and therefore extra costs are required for reworks. Further, air tends to remain between the rigid panels because the contact between the dispensed glue and the rigid panels cannot be controlled when the rigid panels are pressed together. As a result, a great deal of bubbles is formed between the rigid panels, greatly affecting the adhesion effect of the rigid panels and the product yield rate.

In another conventional method, the glue may be replaced by an adhesive tape to prevent using too less or too much glue. However, a significant amount of bubbles still forms between the rigid panels. Since it is unable to separate the rigid panels for rework purpose under use of the adhesive tape, the whole adhesion module has to be discarded as being unserviceable, leading to a poor product quality. Thus, the costs are increased.

Taiwan Patent No. 1331564 discloses the performance of an adhesion process on a liquid crystal displayer. In this patent, rigid panels such as a touch panel and an optical glass are adhered to each other under a substantially vacuum environment. The patent requires operating a vacuum pressing machine to place the touch panel or optical glasses under a cover. Then, a liftable picking device capable of lifting and lowering in the cover is used to pick and lift the panel in a certain height. Next, a liquid crystal displayer including a surface having an adhesive layer is sent to a position under the cover, with the liquid crystal displayer facing the bottom of the cover. Next, a driving device is driven to lower the cover until the opening of the cover is shut. Finally, an air-extracting apparatus is used to extract the air in the cover until the air pressure therein is at a substantially vacuum condition of lower than 760 mmHg, thereby adhering the touch panel and the liquid crystal displayer to each other.

Since the panels require to be fixed during operation of the vacuum pressing machine, the fixing strength between the panels tends to be affected at the moment the cover forms the vacuum therein. As a result, relative shift between the panels or disengagement of the panels may occur, significantly affecting the adhesion of the panels. Although the panels are adhered to each other in the vacuum condition, a significant amount of low-pressure micro-bubbles is still formed. In light of this, it is required to prepare a bubble removal machine that forces the low-pressure micro-bubbles to be absorbed by the glue via a high temperature and a high pressure. Consequently, the patent requires greater time consumptions and higher costs due to extra procedures required while not being able to remove the bubbles that may exist between the panels with a simple manner. Thus, production of products is hindered.

In light of this, it is desired to overcome the aforementioned problems by providing a rigid panel adhesion method that prevents bubbles from forming during the adhesion process of two rigid panels.

### SUMMARY OF THE INVENTION

It is therefore the primary objective of this invention to provide a rigid panel adhesion method that can control the contact between glue and two rigid panels to prevent bubbles from forming during the adhesion process of the rigid panels, thereby improving the adhesion quality and product yield rate.

It is another objective of this invention to provide a rigid panel adhesion method that can perform adhesion between two rigid panels under an atmospheric embodiment, thereby lowering the costs resulted from extra equipments required and simplifying the adhesion process of the rigid panels.

It is yet another objective of this invention to provide a rigid panel adhesion method that can prevent using too less or too much glue, thereby increasing the adhesion strength and preventing losses in costs resulted from too much glue used.

The invention discloses a rigid panel adhesion method including a smearing step and a pressing step. The smearing step smears glue on a surface of a first rigid panel to form a glue layer. The glue layer has a single contact portion being in one-dimensional form of a dot or line. The glue layer has a coverage ratio of no less than 50% over the surface of the first rigid panel. The pressing step touches the contact portion of the glue layer with a second rigid panel, and slowly presses the first and second rigid panels together to discharge gases between the first and second rigid panels, thereby adhering the first and second rigid panels to each other.

Furthermore, the invention discloses a rigid panel adhesion method including a smearing step and a pressing step. The smearing step smears glue on a surface of a first rigid panel to form a plurality of glue layers in parallel. Each of the plurality of glue layers has a single contact portion being in one-dimensional form of a dot or line. The plurality of glue layers has a coverage ratio of no less than 50% over the surface of the first rigid panel. The pressing step touches the contact portions of the plurality of glue layers with a second rigid panel, and slowly presses the first and second rigid panels together to discharge gases between the first and second rigid panels, thereby adhering the first and second rigid panels to each other. Each of the plurality of glue layers has two ends, with two adjacent glue layers spreading to each other in a first speed at the ends thereof and in a second speed at central portions thereof during the pressing step. The second speed is larger than the first speed.

Furthermore, the invention discloses a smearing module including a rigid plate and a scraper. The scraper abuts against a surface of the rigid plate and includes a plate portion having one side forming a scraping portion. An open area is defined between the scraping portion and a first rigid panel when the scraper is placed on the first rigid panel. The open area has a height that is gradually reduced from a center to two sides thereof, so that a glue layer having a single contact portion in the form of a line is formed via the open area.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a flowchart of a rigid panel adhesion method according to a preferred embodiment of the invention.

FIGS. 2a to 2f show operation procedures of the proposed rigid panel adhesion method.

FIGS. 3a to 3e show various forms of a glue layer formed in the rigid panel adhesion method of the invention.

FIGS. 4a to 4d show various forms of a scraper used in the rigid panel adhesion method of the invention, as well as a use of the scraper on a rigid panel.

FIGS. 5a to 5d show other operation procedures of the proposed rigid panel adhesion method.

Photo 1a shows an adhesion result of two rigid panels according to the proposed rigid panel adhesion method of the invention.

Photo 1b shows an adhesion result of two rigid panels according to a conventional rigid panel adhesion method.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

The proposed rigid panel adhesion method is directed to the adhesion of two rigid panels, such as the adhesion of a rigid touch panel onto a surface of a liquid crystal displayer. However, the invention is not limited to the following embodiment.

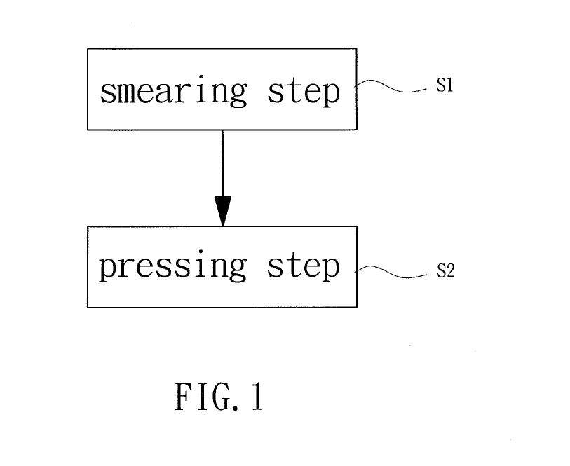

Referring to FIG. 1, a rigid panel adhesion method including a smearing step S1 and a pressing step S2 is disclosed according to a preferred embodiment of the invention.

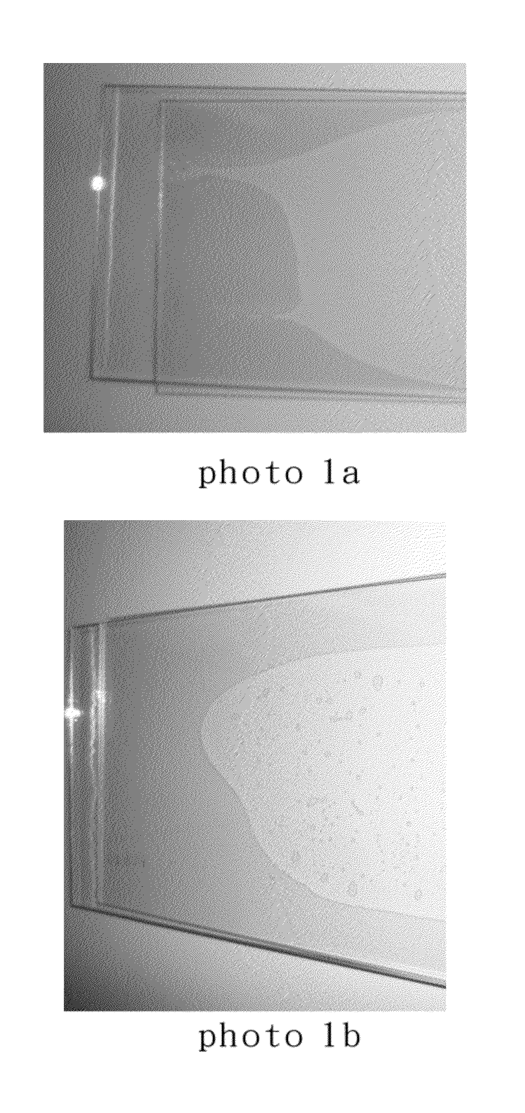

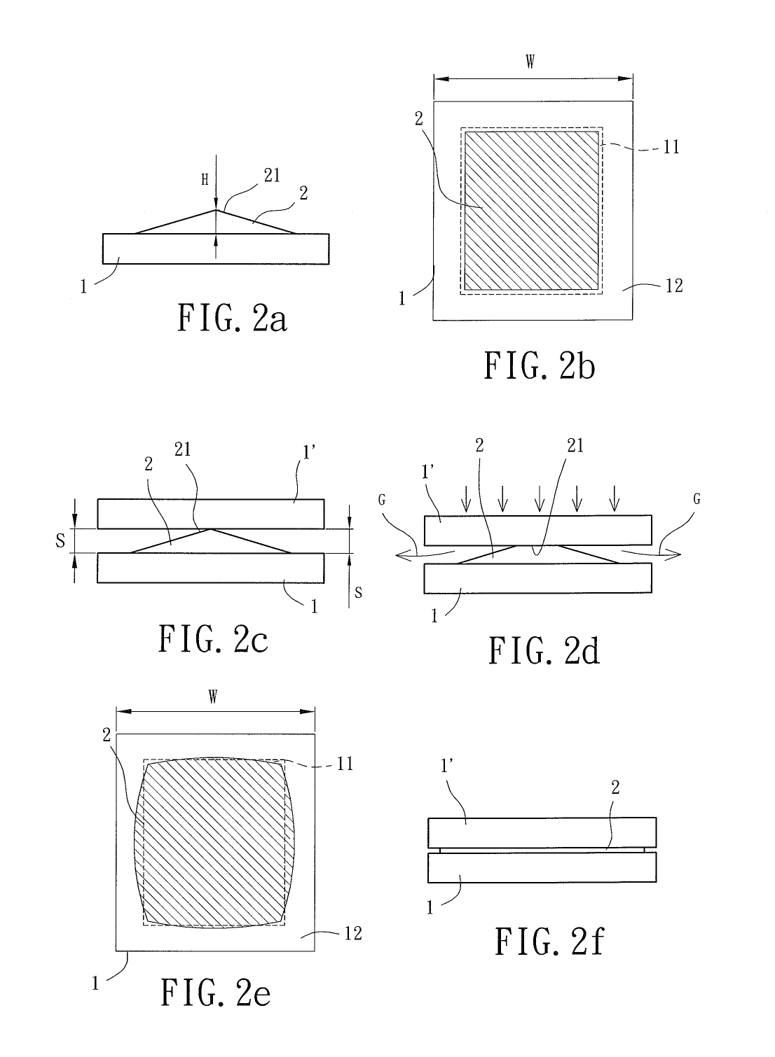

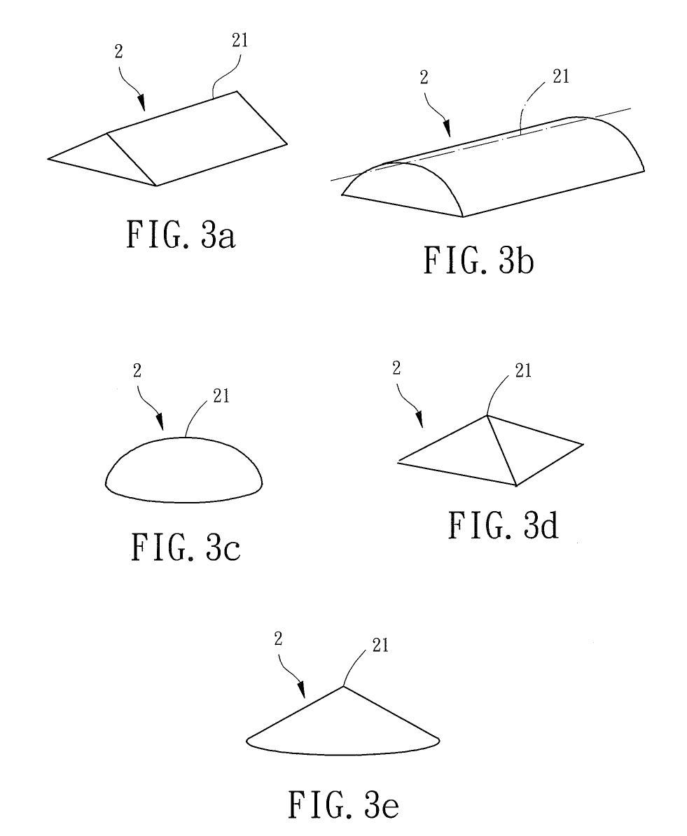

Referring to FIGS. 2a to 2f, the smearing step S1 is adapted to smear glue on a surface of a rigid panel 1 to form a glue layer 2. The glue layer 2 has a single contact portion 21 being in the one-dimensional form of a dot or line. The one-dimensional form generally herein refers to a structure that is not in the form of a plane. Specifically, the glue layer 2 has two opposing ends, one of which abuts against the rigid panel 1 and the other of which forms the contact portion 21. The glue layer 2 has a coverage ratio of no less than 50% over the surface of the rigid panel 1. Specifically, the coverage ratio refers to the proportion of the glue layer 2, which is located in a glue area 11 of the rigid panel 1, to an area of the rigid panel 1, as shown in FIG. 2b. More specifically, the glue layer 2 formed on the rigid panel 1 has an irregular cross section with a thickness that is gradually reduced from a center to outer sides thereof That is, the cross section of the glue layer 2 has a width that is gradually reduced from a bottom to a top thereof The cross section of the glue layer 2 may have a lower side and an upper side. The lower side of the glue layer 2 may be in the form of a line, and the upper side of the glue layer 2 may consist of two straight lines with the same length, thereby rendering the cross section of the glue layer 2 as an isosceles triangle. Alternatively, the upper side of the glue layer 2 may be a curved line, thereby rendering the cross section of the glue layer 2 as a semicircle. Alternatively, the upper side of the glue layer 2 may be a parabolic curve. This will be illustrated in detail with figures later. The top of the cross section serves as the contact portion 21 so that the contact portion 21 is able to shape as a dot or line having one-dimensional form. It can be appreciated that the glue layer 2 may resemble a roof (as shown in FIGS. 3a and 3b), a hemisphere (as shown in FIG. 3c), a pyramid (as shown in FIG. 3d) or a cone (as shown in FIG. 3e). The amount of the glue may depend on the size of the width W of the rigid panel 1, the characteristic of the glue, and the required thickness of the glue layer 2. The glue may be in any amount sufficient for the glue layer 2 to cover no less than 50% of surface area of the rigid panel 1. Preferably, the glue layer 2 has a coverage ratio of 50% to 70% over the surface of the rigid panel 1, allowing the glue in the glue area 11 to slowly spread out over a glue-spreading area 12 of the rigid panel 1 (as shown in FIG. 2e). As such, sufficient glue will be provided in the subsequent pressing step S2 without squeezing the glue out of the rigid panels when the rigid panels are pressed together. Further, the glue layer 2 can only have one contact portion 21, which can be shaped as a dot or line having one-dimensional form in any manner. In such an arrangement, the other rigid panel 1′ will have a point contact or line contact with the contact portion 21 of the glue layer 2 when the rigid panel 1′ contacts the glue layer 2 in the beginning. Therefore, the contact between the rigid panel 1′ and the glue layer 2 may be controlled, so that bubbles that may form under a face contact can be prevented under the point contact or line contact. In addition, an area S with a proper size may be provided between the rigid panels 1 and 1′ so that the useless gases G formed during adhesion process of the rigid panels 1 and 1′ can be discharged through the area S. The rigid panel 1 can be of any size. Preferably, the rigid panel 1 is a middle-sized to large-sized panel having a size of greater than 10 inches for a bubble-free adhesion effect between the rigid panels 1′ and 1.

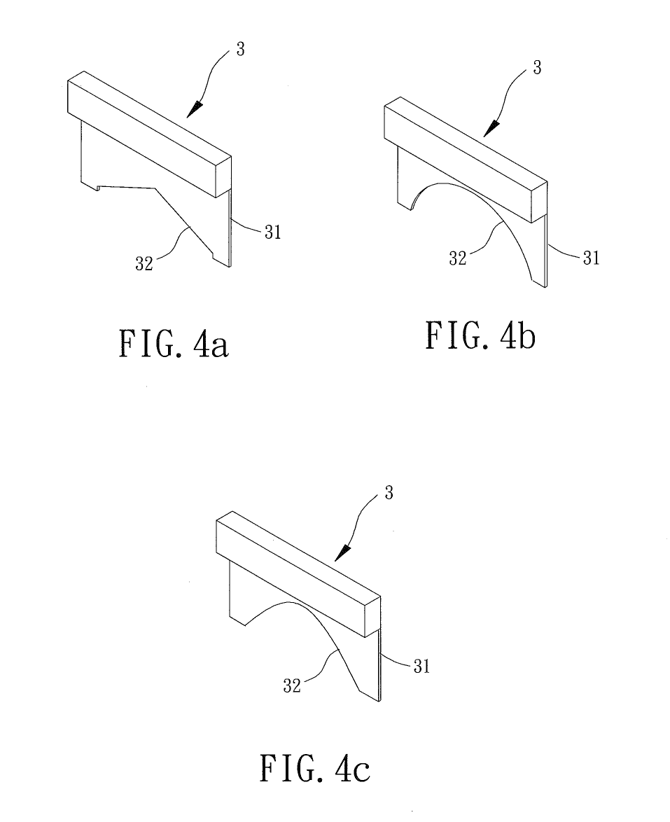

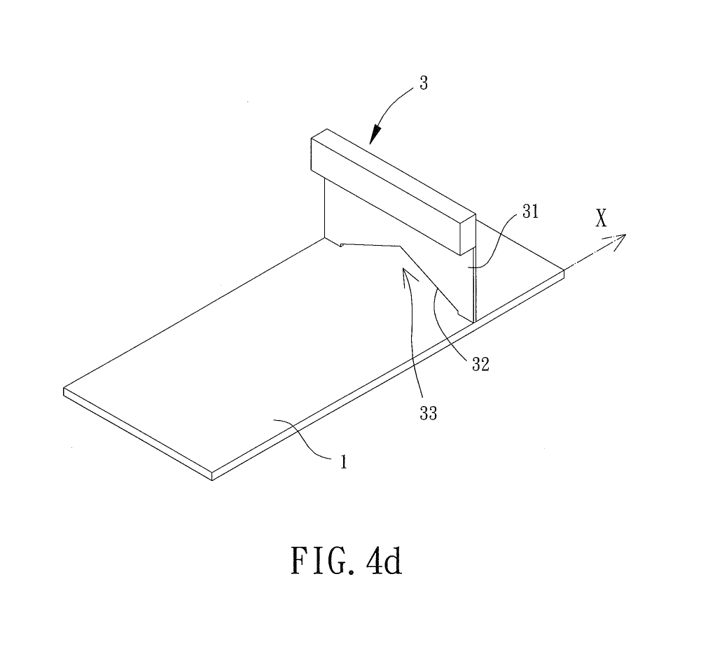

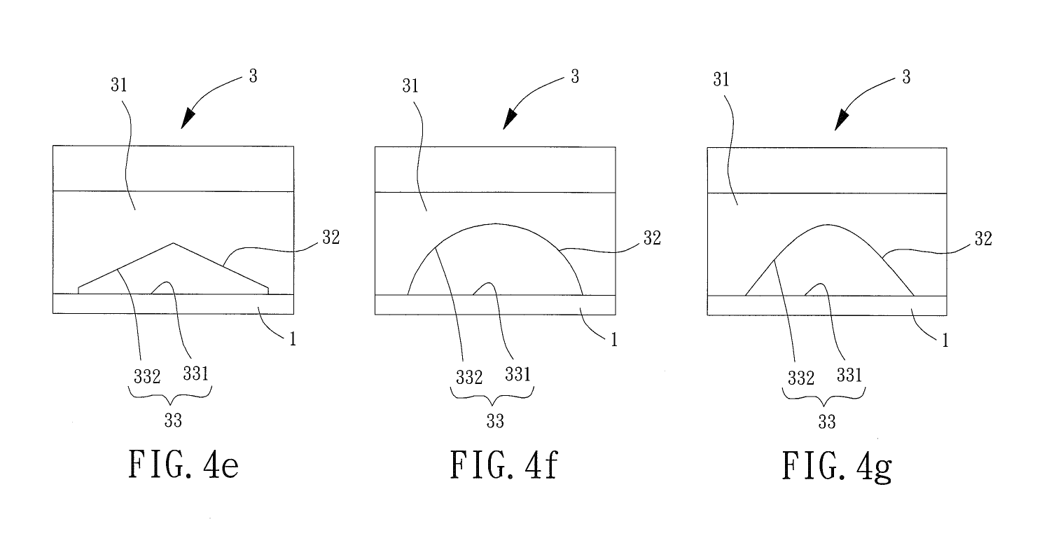

As an example, referring to FIGS. 4a to 4c, a scraper 3 is provided to smear the glue on the surface of the rigid panel 1, so as to form the glue layer 2. However, the glue layer 2 does not necessarily have to be formed using the scraper 3 as disclosed. The scraper 3 and the rigid panel 1 together can form a smearing module. The scraper 3 includes a plate portion 31 having one side forming a scraping portion 32. Specifically, the plate portion 31 has a first side and a second side opposing to the first side. The first side is connected to a handle of the scraper 3. The second side of the plate portion 31 has a reference point. The second side can be divided into left and right parts based on the reference point, with the left and right parts being preferably symmetric to each other. Both the left and right parts of the second side can be of a linear or curved form. The reference point of the second side has a distance to the first side that is smaller than the distance between the first side and any portion of the second side other than the reference point. When the scraper 3 is in use with the rigid panel 1 as shown in FIG. 4d, an open area 33 is defined between the scraper 3 and the rigid panel 1. When viewing in a direction X, the open area 33 has a height that is gradually reduced from a center to two sides thereof That is, the open area 33 has a width that is gradually reduced from a bottom to a top thereof In such an arrangement, the glue layer 2 having the contact portion 21 with line contact can be formed on the rigid panel 1 via the open area 33. When viewing in the direction X, the open area 33 may have a lower side 331 and an upper side 332. As shown in FIG. 4e, the lower side 331 of the open area 33 may be a straight line, and the upper side 332 of the open area 33 may consist of two straight lines with the same length, thereby rendering the open area 33 as an isosceles triangle when viewing in the direction X. Alternatively, as shown in FIG. 4f, the lower side 331 of the open area 33 may be a straight line, and the upper side 332 may be a curved line, thereby rendering the open area 33 as a semicircle when viewing in the direction X. Alternatively, as shown in FIG. 4g, the lower side 331 of the open area 33 may be a straight line, and the upper side 332 may be a parabolic curve when viewing in the direction X. In this embodiment, the open area 33 is particularly formed as the isosceles triangle so that the contact portion 21 of the glue layer 2 may be shaped as a dot or line having one-dimensional form. Herein, the rigid panel 1 has a size of 20 by 10 centimeters, and the glue can be squeezed onto the surface of the rigid panel 1. Preferably, the glue is squeezed on the surface of the rigid panel 1 along a side of the rigid panel 1 (such as an upper side of the rigid panel 1 shown in FIG. 2) to form a glue stick. Then, the amount of the glue is controlled based on the area of the rigid panel 1 and the characteristic of the glue, so that the glue layer 2 with a thickness of 130 to 150 μm is formed between the rigid panels 1′ and 1 after the scraper 3 is driven down the rigid panel 1 to evenly spread out the stick-like glue over the surface of the rigid panel 1. In this arrangement, the glue may be spread out by the scraper 3 to form the glue layer 2 having the contact portion 21 with line contact via the open area 33, as shown in FIG. 2a. At this time, the contact portion 21 of the glue layer 2 is preferably spaced from the rigid panel 1 by a distance H of 250 to 450 μm in a vertical direction. Thus, it is ensured that the rigid panel 1′ has a small contact area with the glue layer 2 when the rigid panel 1′ contacts the glue layer 2 in the beginning. This not only prevents bubbles from forming under face contact but also makes it possible to control the contact between the rigid panel 1′ and the glue layer 2. Thus, the area S may be provided between the rigid panels 1 and 1′ such that the useless gases G can be easily discharged through the area S when the rigid panels 1 and 1′ are pressed together in the subsequent pressing step S2, preventing the bubbles from remaining between the rigid panels 1 and 1′ (as shown in FIGS. 2c and 2d).

Referring to FIGS. 2a to 2f, the pressing step S2 is adapted to contact the contact portion 21 of the glue layer 2 with the rigid panel 1′, and to slowly press the rigid panels 1 and 1′ together for discharging the gases G between the rigid panels 1 and 1′. In this manner, the rigid panels 1 and 1′ can be adhered to each other. Specifically, after the glue is squeezed on the surface of the rigid panel 1 in the smearing step S1, the rigid panel 1′ may be manipulated to contact the contact portion 21 of the glue layer 2. Preferably, the rigid panel 1′ can contact the contact portion 21 of the glue layer 2 when placed in parallel to the rigid panel 1. At this time, the rigid panel 1 is under the glue layer 2 and the rigid panel 1′ is on the glue layer 2. A pressure may be applied to a position of an upper surface of the rigid panel 1′ corresponding to the contact portion 21 of the glue layer 2 in order to slowly spread out the glue as the rigid panel 1′ is pressed against the rigid panel 1. Since the glue spreads from the glue area 11 to the glue-spreading area 12, the glue can evenly cover the surface of the rigid panel 1 for enhanced adhesion strength between the rigid panels 1 and 1′ while the residual gases G between the rigid panels 1 and 1′ can be discharged. Therefore, it may prevent bubbles from forming after the rigid panels 1 and 1′ are adhered to each other, attaining the improved adhesion effect and the improved yield rate. Note the pressing step S2 may be performed under an atmospheric environment without the vacuum equipment and the bubble removal machine, reducing the costs and simplifying the adhesion procedures.

Moreover, the invention may operate a turning machine and a pressing machine. The turning machine and the pressing machine carry the rigid panels 1 and 1′, respectively. The rigid panel 1 carried by the turning machine is smeared with the glue that is shaped by the scraper 3 as the glue layer 2 having the contact portion 21 with line contact via the open area 33. Then, the turning machine is turned over by 180 degrees to align the contact portion 21 of the glue layer 2 with the rigid panel 1′ of the pressing machine. Based on this, the pressing machine may press the rigid panels 1 and 1′ together, slowly spreading out the glue therebetween. In this manner, the residual gases G between the rigid panels 1 and 1′ can be discharged to prevent bubbles from forming in the glue layer 2 when an improved contact effect between the rigid panel 1′ and the contact portion 21 of the glue layer 2 is provided in the beginning of the pressing step S2. Thus, improved adhesion effect and yield rate can be provided. The detailed structures and operations of the turning machine and the pressing machine are obvious to one having ordinary skill in the art, so they are merely described in one embodiment above. However, the turning machine and the pressing machine are not limited to the above embodiment.

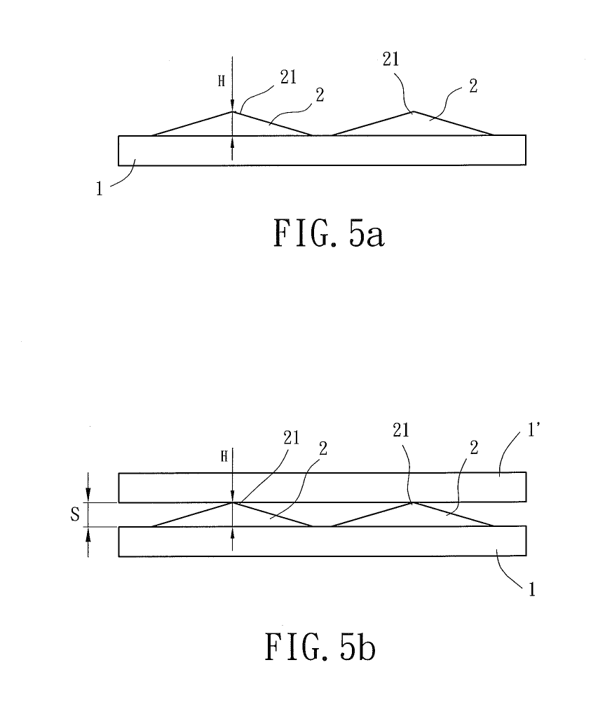

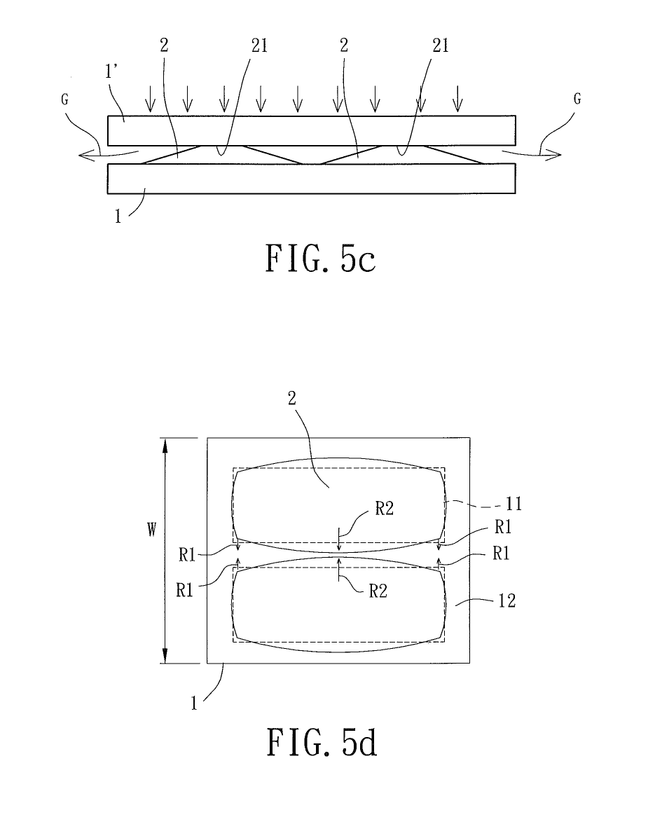

As described in the above embodiment, the invention does provide a bubble-free adhesion effect. In addition, the above embodiment forms the contact portion 21 having one-dimensional form. Thus, when the rigid panels 1 and 1′ are in a larger size as shown in FIGS. 5a to 5d, a plurality of glue layers 2 may be formed on the rigid panel 1. Each glue layer 2 only has a single contact portion with one-dimensional form. Preferably, the plurality of glue layers 2 is parallel to each other on the rigid panel 1, and has a coverage ratio of no less than 50% over the surface of the rigid panel 1. In a preferred case, the plurality of glue layers 2 has a coverage ratio of 50% to 70% over the surface of the rigid panel 1 as previously mentioned. Furthermore, as shown in FIG. 5d, each glue layer 2 has two ends (left and right ends) adjacent to two opposing sides of the rigid panel 1. In FIG. 5d, after the rigid panel 1′ is moved down to touch the contact portions 21 of the two adjacent glue layers 2, the distance between the central portions of two adjacent glue layers 2 is smaller than that between the left ends (or right ends) of the two adjacent glue layers 2. Thus, the two adjacent glue layers 2 can spread to each other in a first speed R1 at the ends thereof and in a second speed R2 at central portions thereof The second speed R2 is larger than the first speed R1, ensuring that the central portions of the adjacent glue layers 2 may contact each other earlier than the ends of the glue layers 2 do during the adhesion process of the rigid panels 1 and 1′. This provides a sufficient area S for gas discharging purpose at the edges of the rigid panels 1 and 1′, as shown in FIGS. 5b and 5c. Thus, not only the bubble-free adhesion effect but also the improved quality and yield rate is attained.

It can be known from the above description that the glue is shaped as the glue layer 2 having the contact portion 21 in one-dimensional form. The glue layer 2 only needs to have a single contact portion 21 no matter the contact portion 21 is in the form of a dot or line. The contact portion 21 is at the top of the glue layer 2 and has a non-plane form. Therefore, a point contact or line contact may be provided between the rigid panel 1′ and the contact portion 21 of the glue layer 2 when the rigid panel 1′ contacts the glue layer 2 in the beginning. In addition, the contact between the rigid panel 1′ and the contact portion 21 may be controlled to ensure a small contact area therebetween, preventing numerous micro-bubbles that may form under a large-area contact between the rigid panel 1′ and the glue layer 2 from forming. Subsequently, a pressure is evenly applied to a position of an upper surface of the rigid panel 1′ corresponding to the contact portion 21, forcing the glue to spread to the glue-spreading area 12. Meanwhile, the residual gases G are also discharged via the area S between the rigid panels 1 and 1′ at the same time, preventing bubbles formed by the residual gases G from forming. Thus, the adhesion quality and product yield rate can be improved.

Further, operations of the invention are not limited to the atmospheric pressure, as many problems that exist in the conventional adhesion methods can be easily solved by shaping the contact portion 21 of the glue layer 2 in one-dimensional form in a simple manner. Therefore, the required time consumption and cost may be relatively reduced. Furthermore, despite the size of the rigid panels and the characteristic of the glue, only the amount of the glue requires to be controlled so that the glue layer 2 is able to cover no less than 50%, particularly 50% to 70%, of surface area of the rigid panel 1. Based on this, the glue in the glue area 11 may spread to the glue-spreading area 12 to provide sufficient glue for an enhanced adhesion effect without causing the spill of the glue. This provides an improved adhesion effect while preventing the losses in costs, defects in product appearance as well as preventing required extra cleaning procedures caused by too much glue used.

Referring to Photo 1, two glasses are shown to be adhered to each other. Photo 1 a shows the adhesion performed by the proposed method, and photo lb shows the adhesion performed by a conventional method. It can be seen in photo 1 that, after the glue layer 2 with the contact portion 21 having line contact is formed on one glass and after the other glass is manipulated to contact the contact portion 21 of the glue layer 2 and further pressed against the glass as taught by the invention, the glasses appear to have a bubble-free adhesion effect and an accurate alignment. The proposed rigid panel adhesion method can prevent bubbles from forming between two rigid panels for an improved adhesion effect and product yield rate.

The proposed rigid panel adhesion method can reduce the costs required for acquisition of related equipments and simplify the adhesion procedures between two rigid panels.

The proposed rigid panel adhesion method can prevent using too less or too much glue, thereby attaining improved adhesion strength and preventing extra losses in costs due to too much glue used.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A rigid panel adhesion method comprising:
a smearing step smearing glue on a surface of a first rigid panel to form a glue layer, wherein the glue layer has a single contact portion being in an one-dimensional form of a dot or line, and the glue layer has a coverage ratio of no less than 50% over the surface of the first rigid panel; and
a pressing step touching the contact portion of the glue layer with a second rigid panel, and pressing the first and second rigid panels together to discharge gases between the first and second rigid panels, thereby adhering the first and second rigid panels to each other.

2. The rigid panel adhesion method as claimed in claim 1, wherein the glue layer has a cross section with a thickness that is gradually reduced from a center to outer sides thereof, and the top of the cross section is the contact portion so that the contact portion is in the one-dimensional form of a dot or line.

3. The rigid panel adhesion method as claimed in claim 2, wherein the cross section of the glue layer has a lower side and an upper side, the lower side of the glue layer is in the form of a straight line, the upper side of the glue layer is in the form of two straight lines with the same length, thereby rendering the cross section of the glue layer as an isosceles triangle.

4. The rigid panel adhesion method as claimed in claim 2, wherein the cross section of the glue layer has a lower side and an upper side, the lower side of the glue layer is in the form of a straight line, the upper side of the glue layer is in the form of a curved line, thereby rendering the cross section of the glue layer as a semicircle.

5. The rigid panel adhesion method as claimed in claim 2, wherein the cross section of the glue layer has a lower side and an upper side, the lower side of the glue layer is in the form of a straight line, the upper side of the glue layer is in the form of a parabolic curve.

6. The rigid panel adhesion method as claimed in claim 1, wherein the glue layer has a coverage ratio of 50% to 70% over the surface of the first rigid panel.

7. The rigid panel adhesion method as claimed in claim 1, wherein the smearing step further places a scraper on the first rigid panel to form an open area between the scraper and the first rigid panel, and the open area has a height that is gradually reduced from a center to two sides thereof, so that the glue layer having the single contact portion in the form of a line is formed via the open area.

8. The rigid panel adhesion method as claimed in claim 1, wherein the contact portion of the glue layer is spaced from the first rigid panel by a distance of 250 to 450 μm in a vertical direction.

9. The rigid panel adhesion method as claimed in claim 1, wherein the glue layer between the first and second rigid panels has a thickness of 130 to 150 μm.

10. A rigid panel adhesion method comprising:
a smearing step smearing glue on a surface of a first rigid panel to form a plurality of glue layers in parallel, wherein each of the plurality of glue layers has a single contact portion being in an one-dimensional form of a dot or line, and the plurality of glue layers has a coverage ratio of no less than 50% over the surface of the first rigid panel; and
a pressing step touching the contact portions of the plurality of glue layers with a second rigid panel, and slowly pressing the first and second rigid panels together to discharge gases between the first and second rigid panels, thereby adhering the first and second rigid panels to each other,
wherein each of the plurality of glue layers has two ends, two adjacent glue layers have spread to each other in a first speed at the ends thereof and in a second speed at central portions thereof during the pressing step, and the second speed is larger than the first speed.

11. A smearing module used in the rigid panel adhesion method as claimed in claim 1 comprising:
a rigid plate; and
a scraper abutting against a surface of the rigid plate and comprising a plate portion having one side forming a scraping portion, wherein an open area is defined between the scraping portion and the rigid panel, and the open area has a height that is gradually reduced from a center to two sides thereof, so that the glue layer having the single contact portion in the form of a line is formed via the open area.

12. The smearing module as claimed in claim 11, wherein the cross section of the glue layer has a lower side and an upper side, the lower side of the glue layer is in the form of a straight line, the upper side of the glue layer is in the form of two straight lines with the same length, thereby rendering the cross section of the glue layer as an isosceles triangle.

13. The smearing module as claimed in claim 11, wherein the cross section of the glue layer has a lower side and an upper side, the lower side of the glue layer is in the form of a straight line, the upper side of the glue layer is in the form of a curved line, thereby rendering the cross section of the glue layer as a semicircle.

14. The smearing module as claimed in claim 11, wherein the cross section of the glue layer has a lower side and an upper side, the lower side of the glue layer is in the form of a straight line, the upper side of the glue layer is in the form of a parabolic curve.
